(19) United States
(12) Patent Application Publication
(10) Pub. No.: US 2014/0209247 A1
(43) Pub. Date: Jul. 31, 2014

(54) VACUUM DRUM, PARTICULARLY FOR A ROLL-FED LABELLING MACHINE, AND VACUUM DRUM PAD

(71) Applicant: SIDEL S.p.A. con Socio Unico, Parma (IT)

(72) Inventors: James CARMICHAEL, Parma (IT); Samadhi ABOUARRAUCHE, Parma (IT)

(73) Assignee: SIDEL S.p.A. con Socio Unico, Parma (IT)

(21) Appl. No.: 14/163,615

(22) Filed: Jan. 24, 2014

(30) Foreign Application Priority Data
Jan. 25, 2013 (EP) 13425015.8

(51) Int. Cl. B65C 9/08

(52) U.S. Cl. CPC B65C 9/08
USPC 156/538

(57) ABSTRACT

The invention relates to a vacuum drum for receiving a labelling material web that is operatively coupled with means for cutting the labelling material we into portions, applying an adhesive on the cut portions of labelling material and for transferring the glued portions to respective items to be labelled. The vacuum drum has a lateral surface having at least one section adapted to cooperate with the portions and delimited, at opposite angular ends, by respective front and back dumping pads. The lateral surface section having one or more panels defining a quasi-cylindrical surface; the front damping pad. and the at least one panel having a material such that the adhesion of the adhesive to the labelling material is greater than the adhesion of the adhesive to the material, and the cohesion of the adhesive being also greater than the adhesion of the adhesive to the material.

### CROSS-REFERENCE TO RELATED APPLICATION

The present application claims priority to European Patent Application Serial No. 13425015,8., filed Jan. 25, 2013, the entirety of which is hereby incorporated by reference.

### FIELD OF THE INVENTION

The present invention relates to a vacuum drum for a labelling machine, particularly for a labelling machine of the type comprising a reel from which a labelling material web is cut into lengths of a predetermined size and applied on items, namely on containers.

### BACKGROUND OF THE INVENTION

In roll-fed labelling machines, containers are carried by a carousel and advanced towards a labelling station along a predetermined container path. The labelling material, in the form of a web wound about a reel, is progressively drawn towards the labelling station along a respective label path, along which a cutting unit is provided for cutting lengths of labelling material of the desired size and for transferring the resulting strips of labelling material, typically by means of a vacuum drum, to the labelling station. As the strips of labelling material, i.e. the newly-cut labels, are transferred from the cutting unit toward the labelling station, a layer of adhesive is typically applied on its surface for subsequently securing them to the surface of the containers being fed to the labelling station.

To this purpose, roll-fed labelling machines comprise a gluing unit comprising, in turn: a glue roller for applying the layer of adhesive to the labels (i.e. the newly-cut strips of labelling material being received from the cutting unit); and means for supplying adhesive to the glue roller in a controlled manner.

FIG. 1 shows schematically the typical arrangement of a roll-led labelling machine 1 comprising a cutting unit 2.

Cutting unit 2 generally comprises (see FIG. 2a) a rotary blade 3 and a stationary blade 4—to which reference is often made also as the counterblade—which are arranged adjacent to vacuum drum 5. In use, the web 6 of labelling material is advanced between the stationary and the rotary blade of the cutting unit, the leading edge of the web being picked, by suction, by the vacuum drum.

Vacuum drum 5 is typically driven to rotate at a speed higher than the speed at which the labelling material web is advanced along the label path, whereby vacuum drum 5 applies a pulling force on the leading edge of the web. When, upon rotation, rotary blade 3 becomes contraposed to stationary blade 4, the labelling material web 6 is cut into portions L. By appropriately setting the vacuum drum rotation speed and the speed at which the labelling material web is advanced, the length of portions (i.e. labels) L can conveniently be adjusted. Cooperation of labelling material web 6 with the surface of vacuum drum 5 shall be described further and in greater detail in the following.

Once picked by the vacuum drum and adhering to the lateral surface thereof by virtue of the relative suction means, the newly-cut labels L are advanced along the label path which is locally defined by the periphery of the vacuum drum. Prior to reaching the label transfer station 7, i.e. the portion of labelling machine 1 where vacuum drum 5 is operatively coupled with the carousel carrying the containers to be labelled, the newly-cut labels reach gluing station 8, at which the vacuum drum is operatively coupled with gluing unit 9.

As illustrated schematically in FIG. 2b, at gluing station glue roller 10 contacts the label L carried, by vacuum drum 5, thereby applying onto its surface a given glue pattern. Accuracy of glue application is paramount to ensure quality of application of the label on the respective container downstream from the gluing station.

To this purpose, the above-mentioned gluing unit 9 has means for supplying adhesive to glue roller 10 in a controlled manner. These means generally include:

means 9A for distributing a continuous flow of adhesive onto the glue roller lateral surface; and means 9B for regulating the amount of adhesive carried on the glue roller lateral surface.

In general, in order to ensure that the lateral surface of the glue roller is homogeneously covered, with adhesive, the adhesive is supplied in an amount greater than the amount strictly necessary for proper gluing of the labels L received by the gluing unit 9. Means for appropriate regulation and control of the amount of adhesive carded on the lateral surface of glue roller 10 therefore generally form part of the gluing unit 9 and typically comprise an adhesive scraper 9B for removing the excess adhesive and smoothing the surface of the adhesive layer applied onto the glue roller lateral surface. Furthermore, gluing unit 9 may comprise means (not illustrated) for collecting the excess adhesive thus removed and for recycling it back to the stationary adhesive distributor bar.

In general, the interaction of cut label L, adhesive and lateral surface of vacuum drum 5 is a rather complex phenomenon.

Firstly, given the high speed at which the various components of a labelling machine are operated in order to meet the current average production requirements, labelling material, adhesive, and vacuum drum come into contact for a remarkably short time, therefore it is difficult to properly analyse what happens nearly instantaneously on a microscopic scale.

Secondly, even if it were possible to observe what occurs nearly instantaneously at such a small scale, it would immediately be apparent that many different factors affect this phenomenon on different levels. By way of example, temperature affects the adhesive rheological behaviour and surface tension. Friction forces exchanged at the interface, between labelling material and vacuum drum on one side, and between labelling material and adhesive on the other side, shall be affected by the material roughness and surface finish, and so forth. Accordingly, making reliable predictions as to the behaviour of different materials in relative movement with respect to each other is virtually impossible, based on an assessment of macroscopic operating conditions alone.

As a matter of fact, operating temperature is a highly relevant parameter, because it directly affects the adhesive rheological properties and matter state, higher temperatures locally promoting adhesive evaporation.

At higher temperatures, as thin layer of glue has been found to build up over the whole of the vacuum drum lateral surface. This layer tends to quickly solidify and adhere rather stubbornly to the vacuum drum surface, so much so that the strips of labelling material subsequently fed to it are found to practically slide over said layer.

At lower temperatures, fine filaments and/or particles of glue have been found to form in the air between the glue roller and the vacuum drum. When these filaments and/or particles contact the vacuum drum surface, the strips of labelling material subsequently fed to it tend to smear the glue deposits over the vacuum drum surface.

As a consequence, periodic maintenance is necessary to remove the glue from the moving surfaces which have become contaminated during use. Over time, in fact, the build-up of glue on the vacuum drum surface can become so significant that a properly timed transfer of a label onto a respective container is made impossible. On top of that, glue tends to accumulate on portions of the vacuum drum surface and/or of the material which should not be reached by it, with an overall undesirable fouling.

Repeated and frequent intervention of an operator results in increased machine downtimes, which are not only undesirable, but oftentimes fully incompatible with certain production throughput requirements. Besides, even providing a labelling machine with replaceable drums and rollers with a view to reducing the entity of downtime, e.g. by having one set of vacuum drum and glue roller cleaned while another one is in operation, has its drawbacks in terms of costs and storage space.

The need is therefore felt in the art for a vacuum drum for labelling machines, particularly for roll-fed labelling machines, by means of which the above drawbacks can, at least in part, be overcome.

In particular, the need is felt in the art for a vacuum drum for labelling machines that reduce glue fouling of moving surfaces, thereby also limiting the entity of machine downtime and possibly eliminating the need for replacement drums and rollers.

It is therefore an object of the present invention to provide a vacuum drum for labelling machines which make it possible to satisfy at least one of the needs mentioned above in a simple and cost-effective manner.

### SUMMARY OF THE INVENTION

The object identified above is achieved by the present invention, as it relates to a vacuum drum according to claim 1. Furthermore, the present invention provides a pad or panel for a vacuum drum of a roll-fed labelling machine according to claim 7.

### BRIEF DESCRIPTION OF THE DRAWINGS

A preferred embodiment is hereinafter disclosed for a better understanding of the present invention, by mere way of non-limitative example and with reference to the accompanying drawings, in which:

FIG. 1 shows a schematic plan view of a labelling machine;

FIG. 2a shows a schematic representation of the layout of the cutting unit of the labelling machine of FIG. 1;

FIG. 2b shows a schematic representation of the layout of the gluing unit of the labelling machine of FIG. 1;

FIG. 3 shows a schematic perspective view of a vacuum drum according to the invention;

FIG. 4 shows a schematic plan view of the vacuum drum of FIGS. 3; and

FIGS. 5A to 5C illustrate test procedures for assessing properties of the materials used in the manufacture of a vacuum drum according to the invention.

### DETAILED DESCRIPTION OF THE INVENTION

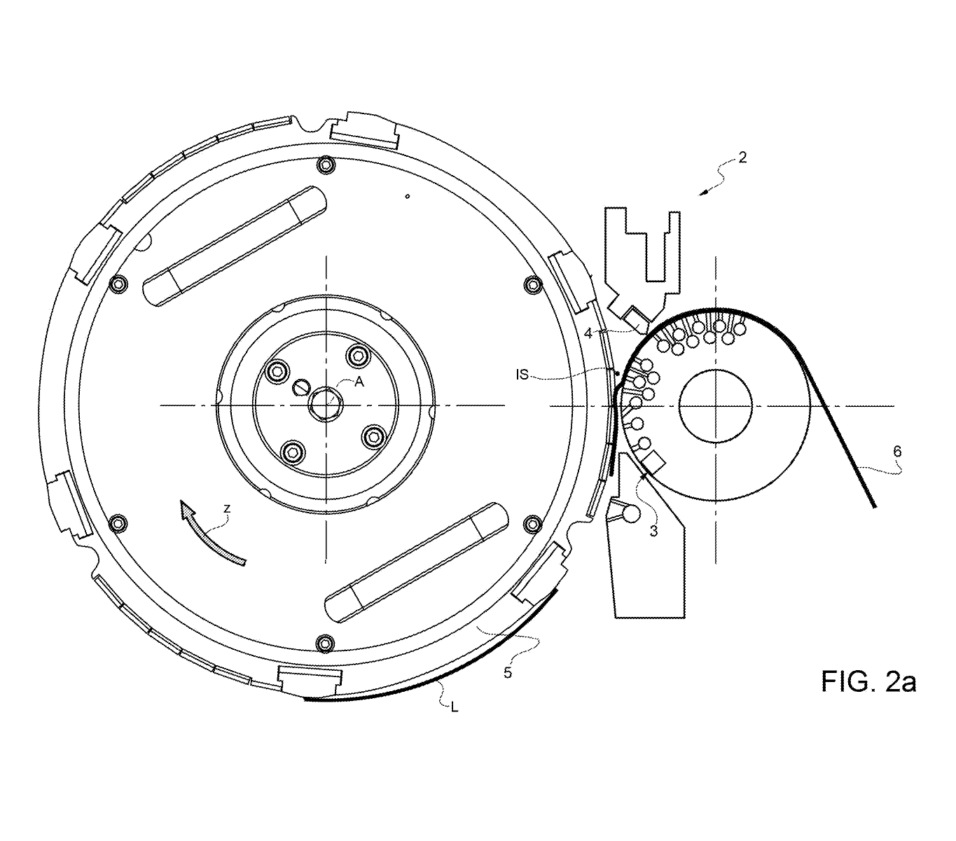

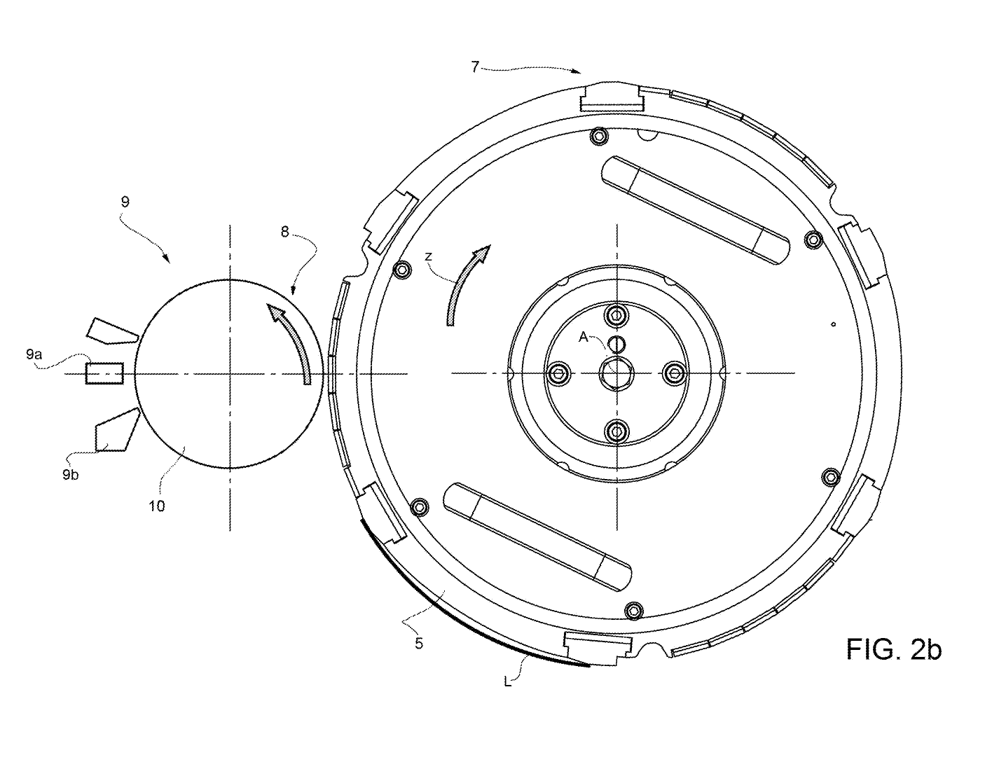

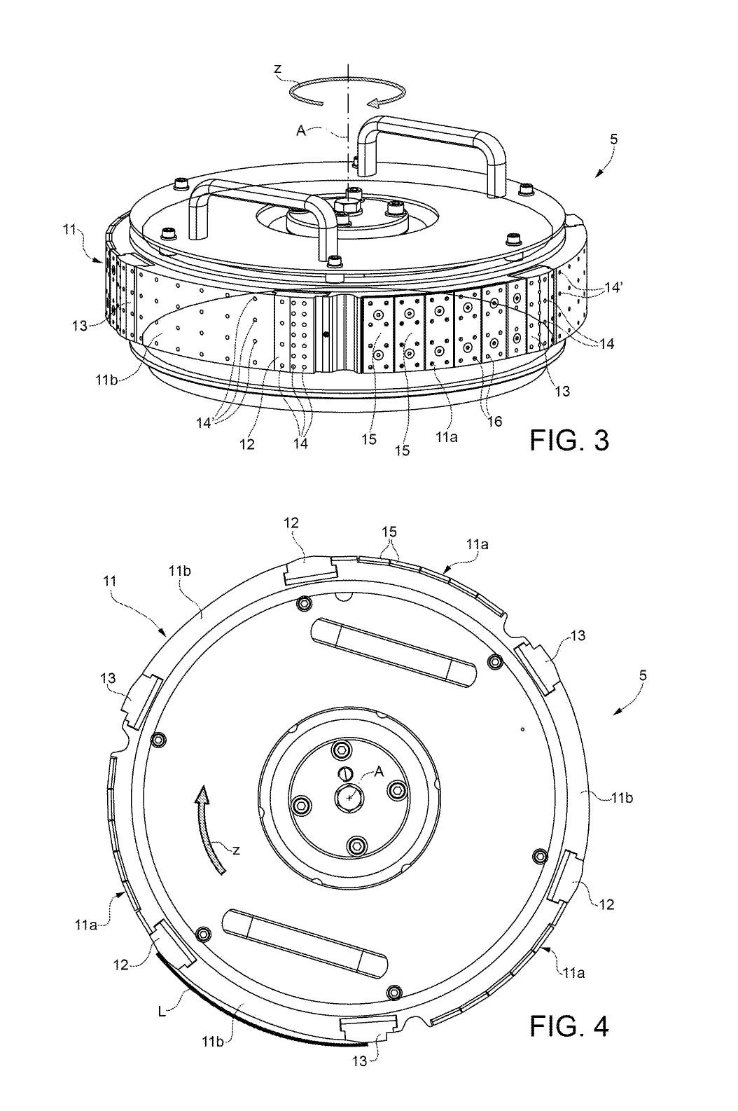

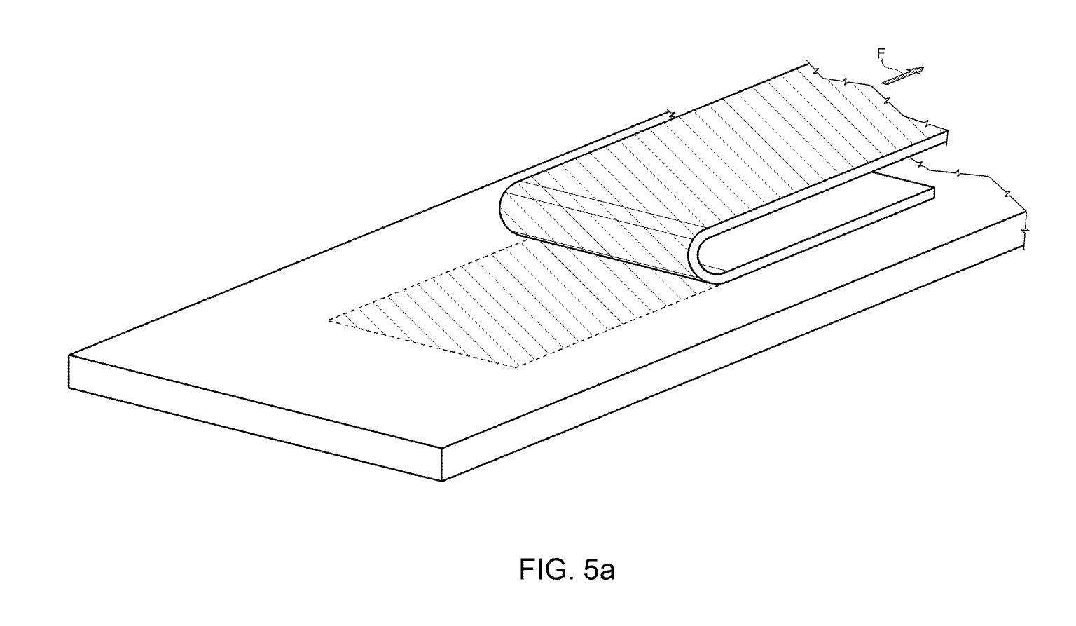

Number 5 in FIGS. 2a, 2b, 3 and 4 indicates a vacuum drum adapted to be used for handling and transferring labels L (only schematically shown in FIG. 4) along an arc-shaped path around an axis A to a label transfer station 7 for applying the labels L to articles or containers, such as bottles (known per se and not shown).

Labels L have a rectangular or square shape that are cut from a web unwound from a supply roll.

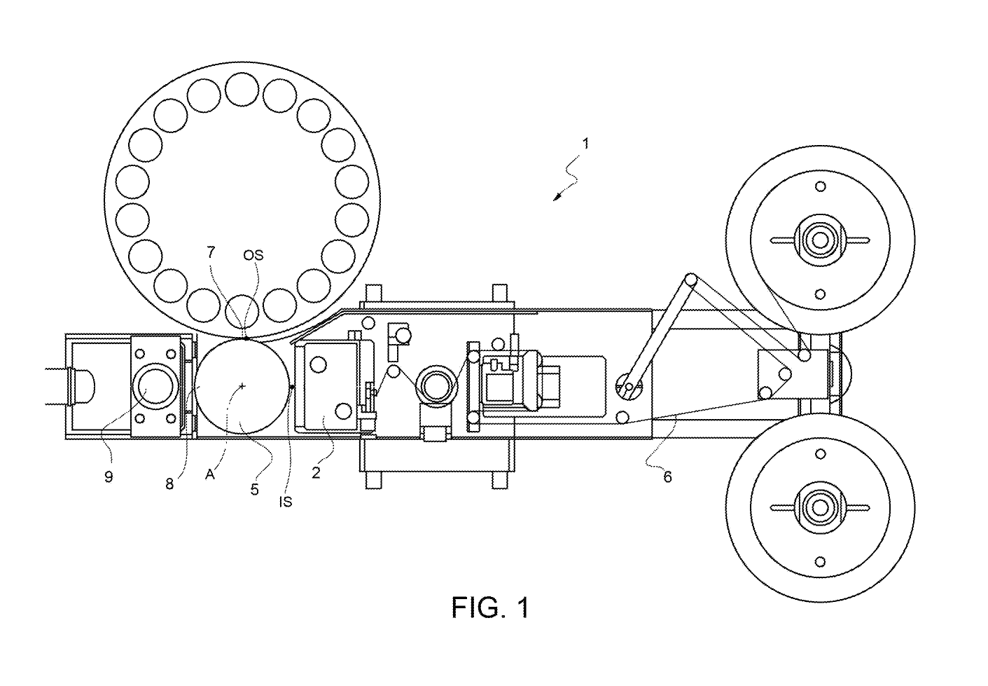

Vacuum drum 5 is adapted to receive a labelling material web 6 at an input station IS (see FIG. 1) and to transfer labels L cut off said web 6 to an output station OS (see FIG. 1) located at a given angular distance from the input station 3 about axis A; the labels L are then applied to articles or containers conveyed by a carousel to labelling station 7.

Vacuum drum 5 is operatively coupled with, and rotatably supported by, a stationary distributor member (not shown) fluidly connected to a vacuum source. Furthermore, vacuum drum 5 is provided with air passages communicating, at one end, with the stationary distributor member at certain angular positions around axis A and, at the other end, with a plurality of vacuum ports formed through an outer lateral surface 11 of vacuum drum 5 for receiving web 6 and retaining labels L once they are cut off web 6, which surface 11 extends transversally with respect to axis A.

In practice, when fluid connection is established between air passages in vacuum drum 5 and the stationary distributor member, air is sucked through said vacuum ports so as to produce a force for retaining a label against the portion of outer lateral surface 11 of vacuum drum 5 where such vacuum ports are formed.

Vacuum drum 5 may be independently driven by a motor (not shown), such as a brushless motor or the like, arranged below the drum itself, or it may be driven by the motor of the labelling machine of which it typically forms part, through suitable gears or transmissions.

As shown in FIGS. 1, 2a, 2b 3 and 4, the outer lateral surface 11 of vacuum drum 5 has an approximately cylindrical lobed shape.

In particular, in the embodiment shown in the Figures, the outer lateral surface 11 of vacuum drum 5 comprises three first sections 11a (which may also be referred to as “pre-pads”) equally spaced angularly from each other around axis A, provided with a first series of ports 16 and adapted to receive and cooperate with the labelling material web 6 and/or respective labels L cut from web 6.

A different number of sections 11a can be provided depending on the capacity of the labelling machine and, even more so, on the length of the labels 2 to be processed. As a minimum configuration, one section 11a shall be provided.

Each section 11a is delimited, at the opposite angular ends, by respective front and back damping pads 13, 12, which are carried on the periphery of vacuum drum 5 at angularly spaced regions thereof, slightly protrude from the outer lateral surface 11 and have the function to engage, in use, with the leading and the trailing ends of the labels 2 to be transferred. To this purpose, pads 12, 13 are provided with as plurality of ports 14 extending transversally with respect to axis A and communicating via one or more corresponding passages with the vacuum source.

In practice, pads 12 and 13 define the zones of the periphery of vacuum drum 5 where transfer of a label L to a respective container occurs. The distance between each pad 12 and the relative upstream pad 13 is, thus, approximately equal to the length of the label 2 to be processed.

Furthermore, each section 11a comprises a plurality of panels 15 fixed to a main body of vacuum drum 5 so as to define a quasi-cylindrical surface. Each panel 15 has ports 16 extending transversally with respect to axis A and communicating, via. one or more corresponding passages, with the vacuum source.

The outer lateral surface 11 of drum 5 further comprises three second sections 11b, often referred to as “inter-pad” zones, which are equally spaced angularly from each other around axis A and are provided with a second series of ports 14′. Each section 11b extends between a relative pair of pads 13, 12 and is in a downstream relationship with a relative section 11a with respect to the direction of rotation of drum 5 as indicated by arrow Z in FIG. 2b.

In other words, by considering the direction of rotation Z, each section or “pre-pad” 11a extends from a relative back pad 13 to a relative front pad 12, whilst the corresponding section 11b extends from the next pad 13 downstream to said pad 12.

Also in this case, it is pointed out that a different number of sections 11b can be provided depending on the capacity of the labelling machine and mainly on the length of the labels L to be processed, the minimum number being one.

When operated, vacuum drum 5 works conventionally by rotating in the direction indicated by arrow Z in FIG. 2b.

Each “pre-pad” section 11a, in use, performs the function to start to attract the labelling material web 6 at the input station IS. In practice, when one of sections 11a reaches input station IS (see FIG. 2a), a portion of labelling, material web 6 can be transferred to vacuum drum 5 in this condition, the active orifices connected to the ports 16 of such section 11a are fluidly connected with the vacuum source, therefore labelling material web 6 begins to be attracted towards vacuum drum 5.

As vacuum drum 5 rotates, typically at a speed higher than the speed at which labelling material web 6 is advanced along the label path, the portion of labelling material web 6 which is cooperating with section ii a slides back until its front end comes in alignment and cooperation with front pad 12.

In practice, as the labelling material web 6 slides back, further rotation of vacuum drum 5 puts ports 14 of front pad 12, as well as ports 14′ of section 11b immediately downstream of front pad 12, into fluidic communication with the source of vacuum. Thus, the leading edge of labelling web material 6 comes to be secured against said front pad 12.

When this condition is reached, via cooperation of labelling material web 6 with the blades of cutting unit 9, a portion (i.e. a label) L is cut off labelling material web 6. Transfer of a label L onto the outer surface of vacuum drum 5 is then completed with the trailing edge of label L coming to securely rest against back pad 13, when the ports 14 thereof are put into fluidic communication with the vacuum source.

Upon completion of this transfer, label L is, accordingly, held at its front end by front pad 12 and at its back end by back pad 13, label L extending substantially over a whole portion 11b of surface 11 of vacuum drum 5. In this configuration, label L is then advanced towards label transfer station 7 where it will be applied onto a respective container.

A reverse process of progressive deactivation of the vacuum through the mentioned ports 14 and 14′ occurs so that the label L can be transferred to a respective article at the output station 4.

In this case, fluidic communication between the lateral surface of vacuum drum 5 and the vacuum source is progressively interrupted upon rotation of vacuum drum 5. Accordingly, label L can be transferred off the surface of vacuum drum 5 and applied onto a respective article, namely a container.

Advantageously, front pad 13 and panels 15 defining the outer surface of each portion 11 a comprise, at least in a superficial portion, a material such that the adhesion of the adhesive to the labelling material is greater than the adhesion of the adhesive to said material, the cohesion of the adhesive being also greater than the adhesion of the adhesive to said material.

A standard, commonly accepted in the art, definition of the term “adhesion” may be found in ASTM D907-12a. Reference is made there to “the state in which two surfaces are held together b interphase forces”, Furthermore, “mechanical adhesion” is intended to describe the adhesion between surfaces in which the adhesive holds the parts together by interlocking action, whereas “specific adhesion” is intended to mean the “adhesion between surfaces which are held together by intermolecular forces of a chemical or physical nature”.

In the present context, the intended meaning of the term “adhesion” is the strength with which a glue, or adhesive, bonds to a given substrate, this strength resulting from a variety of possible interactions.

Similarly, ASTM D907 -12a provides a standard, commonly accepted definition of the term cohesion as “the state in which the constituents of a mass material are held together by chemical and physical forces”. In the context of the present invention, the intended meaning of the term “cohesion” is the internal strength of an adhesive as resulting from a variety of interactions within the adhesive itself.

The meaning of these terms shall be made even clearer by the following description of the different types of interactions occurring at an adhesive-substrate interface and within the adhesive layer. Furthermore, a standard testing procedure shall be provided for assessing whether a vacuum drum material, an adhesive and a labelling material satisfy the adhesion/cohesion relationship introduced above.

Adhesive/substrate interactions typically result in the adhesive displaying a modified molecular structure in the adhesion zone, i.e. at the very interface with the substrate. In particular, adhesion of an adhesive to a substrate is caused by molecular interactions between the two. Among these molecular interactions, a rough distinction can be made between weak intermolecular interactions, such as hydrogen bonds and van der Waal forces, and strong, proper chemical bonds.

Proper chemical bonds, however, only form for very few substrate/adhesive combinations, e.g. between silicone and glass, polyurethane and glass, and epoxy resin and aluminium. For sonic of these bonded joints it has been demonstrated that chemical bonds account for up to 50% of all the interactions.

Furthermore, in addition to the weak intermolecular and chemical adhesion forces, the bonding mechanism occasionally referred to as “micro-mechanical adhesion” can play a significant role, depending on the morphology of the substrate surface. This term derives from the tendency of an adhesive to effectively “mechanically cling” to a roughened substrate surface.

Micro-mechanical adhesion is, in general, only considered to be of secondary importance. However, if there are regular undercuts in the substrate—maybe even introduced by design—which the adhesive flows around, then this can increase the strength of the bonded joint.

Above the adhesion zone, a transition zone is typically found, across which chemical, mechanical and optical properties of the adhesive vary. This zone can have a thickness in the range from a few nanometres up to about a millimetre, depending on the nature of the substrate surface, of the adhesive and the curing conditions (if any).

Farther above, over the adhesion zone, a so-called cohesion zone is found, where the adhesive possesses its nominal properties, as can be derived e.g. from a respective data sheet. These properties are the result of molecular threes such as chemical bonds within the polymeric chains of the adhesive as well as those responsible for the cross-linking between polymeric chains; molecular interactions between adhesive molecules; mechanical adhesion between adhesive molecules.

All these factors affect the properties of the non-cured adhesive, e.g. they determine the theological behaviour and viscosity of the adhesive. When curing of the adhesive occurs, this involves chiefly a solidification process which is based on the formation of new bonds, in particular by cross-linking of short chained molecules to form larger molecules, and by strengthening of already existing bonds.

In general terms, all the zones described above play a part in the determination of the overall strength of the adhesive-substrate bond. Not unlike a link in a chain, it is the zone with the weakest level of interaction that determines the overall strength.

On the other hand, the cohesive properties of an adhesive are already substantially determined by the manufacturer. The user may only try and tailor the curing conditions with a view to optimising their stability and homogeneity.

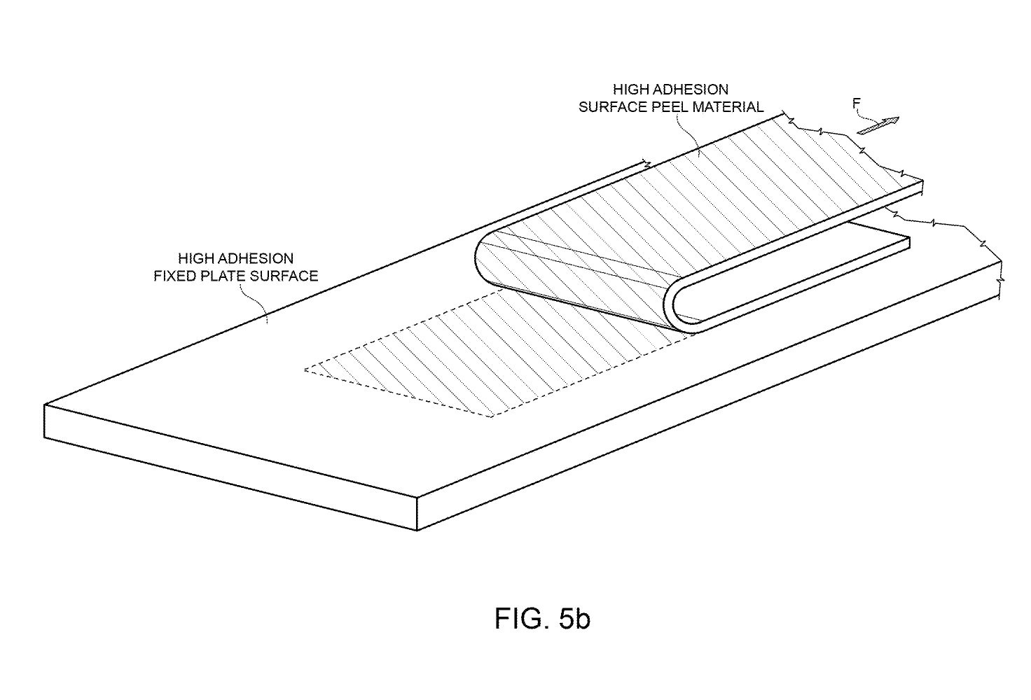

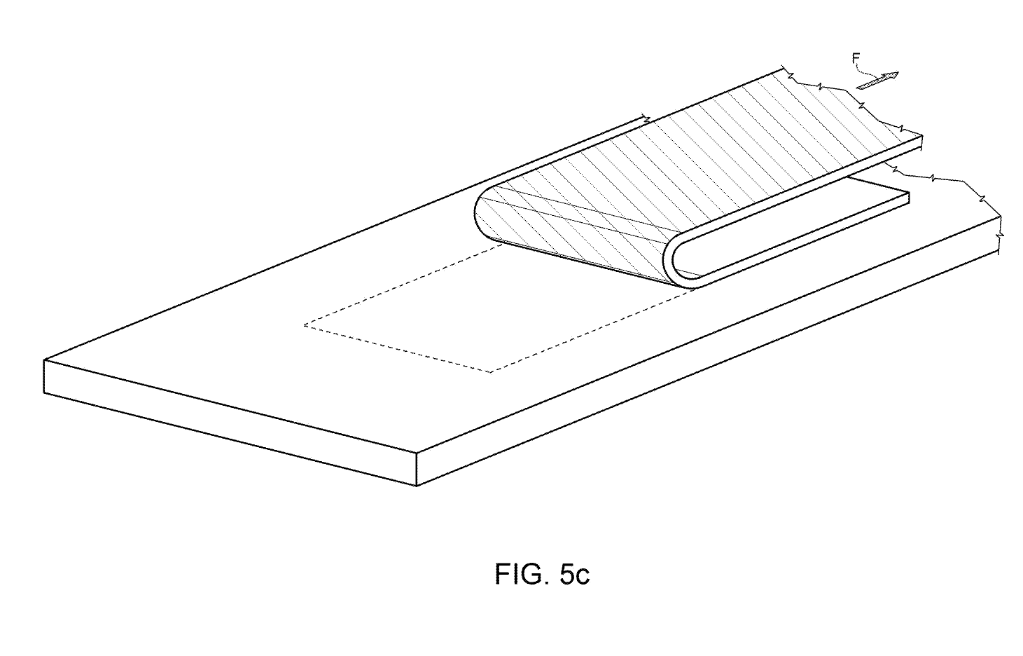

For assessing adhesion, a test method such as the one described in ASTM D903-98 can be used. This test method covers the determination of the comparative peel, or stripping, characteristics of adhesive bonds when tested on standard-sized specimens and under defined conditions of pre-treatment, temperature, and testing machine speed. In practice, the average load F per unit width of bond line required to separate one member (e.g. the labelling material strip L) from the other (e.g. the vacuum drum pad 12,13 or panel 15) over the adhered surfaces at a given separation angle and at a given separation rate is measured (FIG. 5A provides a schematic representation of how to similar test is carried out).

The result of this measurement is therefore generally expressed in kilograms per millimetre of width. However, when tests are carried out for comparative purposes, if samples all having the same bond line width are used, the data relating to the force alone, expressed in kilograms or Newton, can serve as meaningful data.

By way of example, tests were carried out with the same adhesive and the same labelling material. The labelling material used was a typical polypropylene material with a thickness of about 40 μm, whereas the adhesive was a common EVA-based hot-melt adhesive. Several EVA-based hot-melt adhesives are known in the art, which also include a wax/paraffin and antioxidants. The tests gave the following results (see Table 1) which enable a comparison of adhesion properties for several different materials which have been used for the manufacture of panels/pads of vacuum drums for roll-fed labelling machines. Along with the peel force measured in accordance with the ASTM test referred to above, the possible presence of adhesive residue on labelling material and/or drum material was assessed.

TABLE 1
COMPARATIVE EXAMPLES

| | | Adhesive | |
|---|---|---|---|
| Specimen (representative of | | residue | Adhesive residue |
| vacuum drum surface) | Peel Force | on label | on test sample |
| Standard uncoated/untreated | 25N | Yes | Yes |
| aluminium | | | |
| Stainless steel 304 | 20N | Yes | Yes |
| Surface anodized | 20N | Yes | Yes |
| aluminium | | | |

These results are illustrated in FIG. 5A, showing adhesive residues on both label and substrate.

Similarly, for assessing cohesion, tests can be carried out using a test method similar to the above-described ASTM D903-98 for adhesion. Specifically, in order to test cohesion, two surfaces are coated with adhesive and brought into contact with each other, such that they bond together. One of the adhesive-coated surfaces is as rigid material, and the other adhesive-coated surface is a flexible material. The flexible material is then peeled-off as per the ASTM D903-98 standard test. The only provision that has to be made is that the materials are selected such that the material-adhesive bond is stronger than the expected cohesion. See FIG. 5B illustrating the cohesion peel test, wherein adhesive remains bonded to both the rigid material and the flexible material that are peeled-apart by applying force F. In this case, the cohesion within the adhesive is weaker than the adhesion between the adhesive and the materials. Preferably, front pad 12 and panels 15 defining the outer surface of each portion 11a are coated with a polymer-based formulation such that the adhesion of the adhesive to the labelling material is greater than the adhesion of the adhesive to said cured formulation, the cohesion of the adhesive being also greater than the adhesion of the adhesive to said cured formulation.

More preferably, the polymer-based formulation is selected and treated so that the coating has a superficial roughness in the range of 20 to 50 μm and a surface energy density not greater than 30 mJ/m², preferably not greater than 25 mJ/m².

Even more preferably, the polymer-based formulation is a composite comprising a matrix comprising a thermoplastic fluorinated polymer or co-polymer and a plurality of particles dispersed in the polymeric matrix. Advantageously, the coating may have a multi-layer structure.

The fluorinated polymer may be, for example PTFE. The dispersed particles may preferably comprise at least one of the following: nickel, alumina, stainless steel, tungsten carbide.

Preferably, also back pad 13 comprises, at least in a superficial portion thereof, a material such that the adhesion of the adhesive to the labelling material is greater than the adhesion of the adhesive to said material, the cohesion of the adhesive being also greater than the adhesion of the adhesive to said material. More preferably, also back pad 13 is coated with a polymer-based formulation such that the adhesion of the adhesive to the labelling material is greater than the adhesion of the adhesive to said cured formulation, the cohesion of the adhesive being also greater than the adhesion of the adhesive to said cured formulation.

Even preferably, also for back pad 13 the polymer-based formulation is selected and treated so that the coating has a superficial roughness in the range of 20 to 50 μm and a surface energy density not greater than 30 mJ/m², preferably not greater than 25 mJ/m².

In a most preferred manner, also for back pad 13 the polymer-based formulation is a composite comprising a matrix comprising a thermoplastic fluorinated polymer or co-polymer and a plurality of particles dispersed in the polymeric matrix. Advantageously, the coating may have a multi-layer structure.

In practice, pads 12, 13 and panels 15 of vacuum drum can be manufactured by applying the polymer-based coating on a metallic substrate. For favouring a good adhesion of the coating to the substrate, the latter is previously thermally degreased and subsequently sanded to a given roughness profile.

A primer is then applied onto the treated substrate surface in preparation for the application of the coating. Application of every layer is generally followed by curing in oven at temperatures in the range of 300° C. to 400° C.

### EXAMPLE 1

Pads and panels for a vacuum drum surface were prepared by applying, on a rigid substrate of aluminum or steel, a coating comprising a matrix of PTFE and metallic particles, to obtain a coating of approximate overall thickness of 20-50 microns, a roughness of 20-50 microns and a surface energy less than 30 mJ/m2 and preferably less than 25 mJ/m2. The coating also has a static coefficient of friction μ, when interactive with a typical polypropylene labeling material of 0.2 to 0.3.

TABLE 2
COATED SURFACE ACCORDING TO THE INVENTION

| Specimen (representative of | Peel | Adhesive residue | Adhesive residue |
|---|---|---|---|
| vacuum drum surface) | Force | on label | on test sample |
| Coated according to the | <10N | Yes | No |
| invention | | | |

These results are illustrated in FIG. 5C.

Other coatings on similar substrates having similar roughness and made of materials having the same polymeric base and different particles, but having a surface energy within the same range, are expected to work and give the same results. In practice, when a vacuum drum with pads and panels coated according to the invention is operated, the labelling material sliding over the treated surface adheres to the strands, filaments and fine adhesive particles generated in the air between glue roller and vacuum drum, thereby wiping them oil the vacuum drum surface and away as it proceeds further downstream to the output station at which it is applied onto a respective item.

From the analysis of the features of vacuum drum of the invention disclosed above, the advantages which can be obtained by virtue of the invention are clear.

In particular, the vacuum drum of the invention enables a particularly advantageous self-cleaning effect thanks to which a much less frequent intervention on the part of an operator for cleaning the working surfaces is requested. Accordingly, a very convenient reduction of machine idle times is brought about, which is particularly advantageous from a productivity standpoint.

On the other hand, the virtual elimination of strands and particles of adhesive close to the source by which they are originated practically prevents them from reaching other moving parts, the correct operation of which may be hindered by the presence of hardened glue deposits. Also, cleaner working surfaces favour a cleaner application of the label onto the respective container, which can be particularly appreciated from an aesthetic point of view that is always met with approval by the consumer and is therefore desirable in commercial terms.

In addition, the invention ensures that air-home adhesive particles coming into contact with the pre-pad surface Ha are effectively wiped-off the surface of the pre-pad by the sliding movement of the un-cut label, during transfer. Following cutting of the label, the wiped-back adhesive particles remain bonded to the label surface, and entrapped between the front edge surface of the label and front pad 12. Then, at the point of removal OS whereat the label is transferred to the container, the wiped-back adhesive particles remain bonded to the label surface thereby leaving the front pad clean and serviceable for ongoing production, without necessitating manual cleaning. This means that by using the vacuum drum and vacuum drum pads according to the invention, all working surfaces are maintained clean by the labelling process itself.

Finally, it is clear that further modifications and variants of the vacuum drum here disclosed and illustrated can be made without departing from the scope of protection of the independent claims.

What is claimed is:

1. A vacuum drum adapted to receive a labelling material web, configured to be operatively coupled with means for cutting said labelling material web into portions, for applying an adhesive on said cut portions of labelling material and for transferring, downstream from said applying means, the glued portions to respective items to be labelled;
the vacuum drum having a lateral surface comprising at least one section adapted to cooperate with said portions and delimited, at opposite angular ends, by respective front and back damping pads arranged and configured to receive and cooperate, in use, with the leading and trailing edges, respectively, of said portion; and
said lateral surface section comprising one or more panels defining a quasi-cylindrical surface; characterised in that said front damping pad and said at least one panel comprise, at least in a superficial portion thereof, a material such that the adhesion of said adhesive to said labelling material is greater than the adhesion of said adhesive to said material, the cohesion of said adhesive being also greater than the adhesion of said adhesive to said material.

2. The vacuum drum as claimed in claim 1, wherein said front damping pad and said at least one panel are coated with a polymer-based formulation such that the adhesion of said adhesive to said labelling material is greater than the adhesion of said adhesive to said cured formulation, the cohesion of said adhesive being also greater than the adhesion of said adhesive to said cured formulation.

3. The vacuum drum as claimed in claim 2, wherein said polymer-based formulation is selected and treated so that the coating has a superficial roughness in the range of 20 to 50 μm and a surface energy density not greater than 30 mJ/m2, preferably not greater than 25 mJ/m2.

4. The vacuum drum as claimed in claim 2, wherein said polymer-based formulation is a composite comprising a matrix comprising a thermoplastic fluorinated polymer or co-polymer and a plurality of particles dispersed in the polymeric matrix.

5. The vacuum drum as claimed in claim 2, wherein said polymer-based formulation is applied to said front damping pad and said at least one panel as a multi-layer coating.

6. The vacuum drum as claimed in claim 4, wherein said particles comprise at least one of the following: nickel, alumina, stainless steel, tungsten carbide.

7. The vacuum drum as claimed in claim 1, wherein said back pad also comprises, at least in a superficial portion thereof, a material such that the adhesion of the adhesive to the labelling material is greater than the adhesion of the adhesive to said material, the cohesion of the adhesive being also greater than the adhesion of the adhesive to said material.

8. A pad or panel for the manufacture of the lateral surface of a vacuum drum according to claim 1.
